(19) United States
(12) Patent Application Publication
(10) Pub. No.: US 2019/0320665 A1
(43) Pub. Date: Oct. 24, 2019

(54) Process for Preparing a Baked Product with Anti-Staling Amylase and Peptidase

(71) Applicant: Novozymes A/s, Bagsvaerd (DK)

(72) Inventors: Henrik Lundkvist, Malmo (SE); Merete Møller Engelsen, Frederiksberg (DK); Gitte Budolfsen Lynglev, Frederiksberg (DK); Peter Rahbek Ostergaard, Virum (DK)

(73) Assignee: Novozymes A/S, Bagsvaerd (DK)

(21) Appl. No.: 16/506,463

(22) Filed: Jul. 9, 2019

Related U.S. Application Data
(63) Continuation of application No. 13/810,276, filed on Mar. 25, 2013, now Pat. No. 10,390,538.
(60) Provisional application No. 61/366,321, filed on Jul. 21, 2010.

(30) Foreign Application Priority Data
Jul. 21, 2010 (EP) 10170322.1
Oct. 13, 2010 (EP) 10187453.5

(51) Int. Cl. A21D 8/04

(52) U.S. Cl. CPC A21D 8/042

(57) ABSTRACT

The present invention provides processes for preparing dough which comprises at least one anti-staling amylase and at least one peptidase. In addition, the present invention provides baked products produced there from which have a desirable degree of softness and improved springiness.

### CROSS-REFERENCE TO RELATED APPLICATIONS

This application is a continuation of U.S. application Ser. No. 13/810,276 filed on Mar. 25, 2013 which is a 35 U.S.C. 371 national application of PCT/EP2011/062341 filed Jul. 19, 2011 which claims priority or the benefit under 35 U.S.C. 119 of European application nos. 10170322.1 and 10187453.5 filed Jul. 21, 2010 and Oct. 13, 2010 and U.S. provisional application No. 61/366,321 filed Jul. 21, 2010, the contents of which are fully incorporated herein by reference.

### REFERENCE TO A SEQUENCE LISTING

This application contains a Sequence Listing in computer readable form, which is incorporated herein by reference.

### FIELD OF THE INVENTION

The present invention relates to processes for preparing dough which includes at least one anti-staling amylase and at least one peptidase. In addition, the present invention provides baked products produced there from which have a desirable degree of softness and improved springiness.

### BACKGROUND OF THE INVENTION

It is well known that bread loses many of its fresh baked qualities over time. The term staling is used to describe such undesirable changes in the properties of bread over time which can include, for example, loss of softness (or an increase in the firmness of the crumb), a decrease in the elasticity of the crumb (loss of springiness), and changes in the crust texture which can become tough and leathery. Addressing certain of these undesirable changes may exacerbate other undesirable changes. For example, although addition of an anti-staling amylase to the dough retards crumb firming of the resultant baked product over time, the dose of amylase that may be employed to produce an acceptable crumb is limited. In particular, an excessive dose of anti-staling amylase produces deleterious effects on the resultant baked product including an unacceptably sticky or gummy crumb. Thus, the balance of specific components to achieve the desired end product is delicate, complex and highly unpredictable.

As consumers associate the softness and springiness of bread with freshness, there is a need for baked products with a crumb having a desirable degree of softness as well as improved springiness.

### SUMMARY OF THE INVENTION

The freshness of a baked product is often judged by consumers who apply pressure to the crumb to test for softness. Unless the baked product has sufficient resilience to spring back to its approximate original shape following such testing, the baked product may remain deformed, rendering it aesthetically unappealing and suggestive of bread which is not fresh. In one aspect, the present invention provides baked products that maintain properties associated with freshness including a desirable degree of softness, as well as springiness, for at least 14 days and even 21 days or more after baking.

In one aspect, the present invention provides processes for producing dough that incorporate a peptidase, whereby the baked product produced there from has and maintains a desirable degree of springiness. Additionally, the incorporation of peptidase in dough permits an amount of anti-staling amylase to be used in the dough such that the resultant baked product produced there from has and maintains desirable crumb qualities including a desirable degree of softness and springiness for at least 14 days and even 21 days or more after baking. It has been discovered that, the incorporation of peptidase in combination with an anti-staling amylase in the dough allows for a higher amount of anti-staling amylase to be employed, while still producing a baked product that has desirable crumb qualities including a favorable degree of moistness. Furthermore, the incorporation of peptidase in dough provides a baked product that has an increase in free water mobility and/or a decrease in the rate of moisture loss over time which provides a baked product with a desirable moistness perception.

In one aspect, the present invention provides processes for producing dough, which processes include an anti-staling amylase in combination with a peptidase, whereby the baked product produced there from has and maintains a desirable degree of softness and improved springiness, as compared to bread made without such combination.

In another aspect, the present invention provides bread with excellent crumb quality over a period of at least 3 weeks shelf-life (or storage) following baking, as compared to current baked-to-inventory bread, which has a shelf-life of approximately 3-12 days. Excellent crumb quality means the crumb retains such fresh-baked qualities as softness, springiness and elasticity over its shelf-life. These qualities during shelf-life remain similar to those of fresh bread, thereby enhancing the desirability to a consumer.

In yet another aspect of the invention, there is provided a premix of an anti-staling amylase and a peptidase, said premix being useful as an additive to dough to produce a baked product, such as bread with a shelf-life of at least three weeks.

In another aspect of the invention, there is provided a method of increasing the ability to add greater amount of anti-staling amylase to a dough or baked product without experiencing deleterious effects commonly associated with such greater amounts, e.g., unacceptable moistness in the bread crumb. The method includes adding a combination of the anti-staling amylase and a peptidase.

In another aspect of the invention, bread prepared from dough with the combination of peptidase and anti-staling amylase has a desirable level of firmness that is comparable or less than that of bread prepared from dough with anti-staling amylase but no peptidase following storage for 4 to 21 days after baking.

In still another aspect of the invention, there is provided a process and bread product prepared from dough with the combination of peptidase and anti-staling amylase, which results in a desirable level of springiness in the final baked product that is greater than that of bread prepared from dough with amylase but no peptidase following storage for 4 to 21 days after baking.

In another aspect, the invention provides processes for preparing a baked product which includes: (i) adding to either a flour that is used to form a dough or directly to a dough: (a) at least one anti-staling amylase in an amount sufficient to decrease firmness of the baked product; and (b) at least one peptidase in an amount sufficient to increase springiness of the baked product.

In another aspect, the invention provides baked products produced by a process comprising: (i) adding to either a flour that is used to form a dough or directly to a dough: (a) at least one peptidase in an amount sufficient to increase the springiness of the baked product and (b)at least one anti-staling amylase in an amount sufficient to decrease the firmness of the baked product; and (ii) baking the dough to form the baked product.

In one aspect, the invention provides compositions for preparing dough for baking comprising: (i) at least one peptidase; (ii) at least one anti-staling amylase; (iii) optionally, at least one or more other enzymes; and (iv) optionally, flour.

### DETAILED DESCRIPTION OF THE INVENTION

As used herein the following terms shall have the definitions set forth below.

As used herein the term “firmness” with regard to the crumb of a baked product refers to the amount of weight that compresses the crumb by 20% as detailed in the Texture Analyzer method described below.

As used herein the term “springiness” with regard to the crumb of a baked product refers to the resiliency of the crumb to pressure applied thereto. The springiness of a baked product may be quantitated using the Texture Analyzer method described below. In preferred embodiments of the invention the springiness is maintained for a storage period of at least 4-14 days, 4-21 days, and/or 14-21 days after baking. By the term “maintained springiness” is understood that the relative springiness is reduced by no more than 10%, no more than 7.5%, no more than 5%, or even no more than 2.5% during the storage period. Most preferably the relative springiness is substantially constant or even slightly increased during the storage period.

As used herein the term “staling” describes undesirable changes in the properties of bread over time, including an increase in the firmness of the crumb, a decrease in the elasticity of the crumb, and/or changes in the crust which becomes tough and leathery. Quantitatively, staling also refers to a decrease in the amount of free water present in a baked product over time. As the moist feeling of bread crumb is related to the amount of free water present, it is desirable for bread to retain a sufficient amount of free water to maintain the moist feeling associated with freshness.

The terms “shelf-life” or “storage” are used interchangeably and mean a period of time after baking, including the time while the baked product is warehoused, shipped, on-the-shelf at a point-of-purchase until consumption. “Shelf-life” further connotes the time during which the bread retains enough of its fresh-baked properties to still be considered “fresh”, as discussed herein. For purposes of the present invention, the shelf-life will include at least a period (storage period) from 4 to about 21 days, and more preferably a period of about 14 to 21 days. While conditions of temperature and moisture may vary during storage, preferably the temperature is about -25° C. to about 30° C., more preferably the temperature is about 5° C. to about 25° C. and the relative humidity is about 20% to about 100%. Baked products using the inventive compositions and processes may even retain their freshness over time even under conditions outside of these ranges.

### Peptidases

As used herein the term “peptidase” refers to a proteolytic enzyme that hydrolyses a peptide bond. There are two types of peptidases, exopeptidases and endopeptidases. An “exopeptidase” or an “exoproteinase” is an exo-acting peptidase that hydrolyses peptide bonds from the N-terminus or C-terminus of a peptide and may be further classified by the number of amino acids cleaved off from the peptide. An “endopeptidase” or an “endoproteinase” is an endo-acting peptidase that is able to hydrolyse any peptide bond in a peptide. However, as endopeptidases often have catalytic sites involving binding to several amino acids (often on both sides of the cleavage point) endopeptidases in general have preference for non-terminal peptide bonds. Peptidases may be classified based on the reaction they catalyze (i.e., functionally as exemplified by the Nomenclature Committee of IUBMB) or based on 3-D structure, homology and similar characteristics (as exemplified by MEROPS classification).

Exemplary exopeptidases for use in the present invention include ExoP1 (Uniprot:q2ulm2) from Aspergillus oryzae (SEQ ID NO:1) (MEROPS class: MH-M28A), ExoP2 (Uniprot:q2tz11) from Aspergillus oryzae (SEQ ID NO:2) (MEROPS class: SC-S10), ExoP3 (Uniprot:Q48677) from Lactococcus lactis cremori (SEQ ID NO:3) (MEROPS class: MH-M42), ExoP4 (Uniprot:q65dh7) from Bacillus licheniformis (SEQ ID NO:4) (MEROPS class: MH-M28), ExoP5 (Uniprot:q2tya1) from Aspergillus oryzae (SEQ ID NO:5) (MEROPS class: SC-S10), ExoP6 (Uniprot:q2uh35) from Aspergillus oryzae (SEQ ID NO:6) (MEROPS class: SC-S9B), and ExoP7 from Aspergillus oryzae (SEQ ID NO:7) (MEROPS class: AA-A1).

Exemplary endopeptidases include EndoP1 (Uniprot:p06832) from Bacillus amyloliquefaciens (SEQ ID NO:11) (MEROPS class: MH-M4), EndoP2 from Aspergillus oryzae (SEQ ID NO:12) (MEROPS class: PA-S1A), EndoP3 (Uniprot:p35049) from Fusarium oxysporium (SEQ ID NO:8) (MEROPS class: PA-S1A), EndoP4 (Uniprot:p00799) from Rhizomucor miehei (SEQ ID NO:9) (MEROPS class: AA-A1), EndoP5 from Alicyclobacillus sp. (SEQ ID NO:15) (MEROPS class: GA-G1), EndoP6 from Thermoascus aurantiacus (SEQ ID NO:14) (MEROPS class: MH-M35), EndoP7 from Aspergillus oryzae (SEQ ID NO:12) (MEROPS class: MH-M36), and EndoP8 (Uniprot:p00761) from Sus scrofa (pig) (SEQ ID NO:10) (MEROPS class: PA-S1A).

Combinations of these peptidases may also be used. Also preferred for the invention is a peptidase being at least 50%, at least 60%, at least 70%, at least 80%, at least 90%, at least 95%, or even at least 99% identical to any of SEQ ID NOS: 1 to 12.

In one embodiment, at least one peptidase is chosen from EndoP2, ExoP4, ExoP5, or EndoP3. Combinations of the peptidases may also be used.

The peptidase may have optimum activity at pH 3-10. However, it is sufficient that the peptidase have some activity under the conditions of temperature and pH in which the dough is exposed during processing.

The peptidase may be derived from fungal sources, e.g., an Acremonium, Aspergillus, Aureobasidium, Bjerkandera, Ceriporiopsis, Chrysosporium, Coprinus, Coriolus, Cryptococcus, Filibasidium, Fusarium, Humicola, Magnaporthe, Mucor, Myceliophthora, Neocallimastix, Neurospora, Paecilomyces, Penicillium, Phanerochaete, Phlebia, Piromyces, Pleurotus, Schizophyllum, Talaromyces, Thermoascus, Thielavia, Tolypocladium, Trametes, or Trichoderma cell.

For example, the sources may be an Aspergillus awamori, Aspergillus foetidus, Aspergillus fumigatus, Aspergillus japonicus, Aspergillus nidulans, Aspergillus niger, Aspergillus oryzae, Bjerkandera adusta, Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum, Coprinus cinereus, Coriolus hirsutus, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium suiphureum, Fusarium torulosum, Fusarium trichothecioides, Fusarium venenatum, Humicola insolens, Humicola lanuginosa, Mucor miehei, Myceliophthora thermophila, Neurospora crassa, Penicillium purpurogenum, Phanerochaete chrysosporium, Phiebia radiata, Pleurotus etyngii, Thermoascus aurantiacus, Thielavia terrestris, Trametes villosa, Trametes versicolor, Trichoderma harzianum, Trichoderma koningii, Trichoderma longibrachiatum, Trichoderma reesei, or Trichoderma viride cell.

The peptidase may be derived from a bacterial source, e.g., examples of bacterial sources of enzymes include a gram-positive bacterial such as an Alicyclobacillus. Bacillus, Clostridium, Enterococcus, Geobacillus, Lactobacillus, Lactococcus, Nocardiopsis, Oceanobacillus, Staphylococcus, Streptococcus, or Streptomyces and gram-negative bacterial polypeptide such as a Campylobacter, E. coli, Flavobacterium, Fusobacterium, Helicobacter, Ilyobacter, Neisseria, Pseudomonas, Salmonella, or Ureaplasma maltogenic alpha-amylase. Particular bacterial sources of enzymes include Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus subtilis, Bacillus thuringiensis, Nocardiopsis prasina, Streptococcus equisimilis, Streptococcus pyogenes, Streptococcus uberis, or Streptococcus equi subsp. Zooepidemicus, Streptomycin achromogenes, Streptomyces avermitilis, Streptomyces coelicolor, and Streptomyces griseus.

The peptidase may be derived from a mammal sources, e.g., such as from a pig (Sus scofa).

The peptidase may be added in an amount such that one or more of the following properties is observed in the baked product produced there from: (i) the degree of springiness as measured using the Texture Analyzer method described herein is at least 0.5%, at least 1%, at least 2%, or even at least 3% greater compared to a control baked product prepared from dough of the same composition but in the absence of the combination of anti-staling amylase and peptidase following storage for at least 21 days after baking; (ii) the rate of free water loss as measured using the NMR method described herein is reduced relative to a control baked product prepared from dough of the same composition but in the absence of the combination of anti-staling amylase and peptidase following storage for at least 21 days after baking; (iii) the percentage of free water mobility as measured using the NMR method described herein is at least 0.5%, at least 1%, at least 2% or even at least 3% less compared to a control baked product prepared from dough of the same composition but in the absence of the combination of anti-staling amylase and peptidase following storage for at least 21 days after baking.

In one embodiment, the amount of peptidase added may be at least about 0.01 mg peptidase per kg flour in total added to the dough. In one embodiment, the amount of endopeptidase added may be about 0.01 mg/kg to about 35 mg/kg flour in total added to the dough. In another embodiment, the amount of exopeptidase added may be about 0.1 mg/kg to about 10 mg/kg flour in total added to the dough.

### Anti-Staling Amylases

Useful anti-staling amylases may be of the fungal or bacterial type, e.g., a maltogenic alpha-amylase from B. stearothermophilus or an alpha-amylase from Bacillus, e.g. B. lichenifornis or B. amyloliquefaciens, a beta-amylase, e.g., from plant (e.g., soy bean) or from microbial sources (e.g., Bacillus), a glucoamylase, e.g., from A. niger, or a fungal alpha-amylase, e.g., from A. oryzae. Suitable exoamylases are described in U.S. Pat. No. RE38,507, incorporated herein by reference in its entirety.

For example, suitable, non-limiting examples of anti-staling amylases include microbial exoamylases as these are easier to produce on a large scale than exoamylases of, for instance, plant origin.

An example of a suitable exoamylase is a maltogenic amylase producible by Bacillus strain NCIB 11837, or one encoded by a DNA sequence derived from Bacillus strain NCIB 11837 (the maltogenic amylase is disclosed in U.S. Pat. Nos. 4,598,048 and 4,604,355, the contents of which are incorporated herein by reference). This maltogenic amylase is capable of hydrolyzing 1,4-alpha-glucosidic linkages in starch, partially hydrolyzed starch and oligosaccharides (e.g. maltotriose). Maltose units are removed from the non-reducing chain ends in a stepwise manner. The maltose released is in the alpha-configuration. In the U.S. patents mentioned above, the maltogenic amylase is indicated to be useful for the production of maltose syrup of a high purity.

Another maltogenic amylase which may be used in the present process is a maltogenic-beta-amylase producible by Bacillus strain NCIB 11608 (disclosed in EP 234 858, the contents of which are hereby incorporated by reference).

The anti-staling amylase may be added in a sufficient amount such that the baked product produced there from has a degree of firmness, as measured using the Texture Analyzer method described herein, that is comparable or less than that compared to a control baked product prepared from dough without the added combination of anti-staling amylase and peptidase, and this degree of firmness lasts for at least 4 to 21 days after baking, and preferably 14 to 21 days after baking.

In one embodiment, the anti-staling amylase may be added in an amount of 0.1-10,000 MANU, preferably 1-5000 MANU, more preferably 5-2000 MANU, and most preferably 10-1000 MANU, per kg of flour. One MANU (Maltogenic Amylase Novo Unit) may be defined as the amount of enzyme required to release one micromol of maltose per minute at a concentration of 10 mg of maltotriose (Sigma M 8378) substrate per ml of 0.1 M citrate buffer, pH 5.0 at 37° C. for 30 minutes.

In one embodiment, the anti-staling amylase is a recombinant maltogenic amylase encoded by a DNA sequence derived from Bacillus strain NCIB 11837, described in U.S. Pat. No. 4,598,048 commercially known as Novamyl™ (available from Novozymes A/S). Typically, Novamyl™ is added in an amount that is at least 100 ppm/kg. In one embodiment, NovamylTM is added in an amount that is up to 5000 MANU/kg. In one embodiment, Novamyl™ is added in an amount that is in a range of at least 100 MANU/kg flour to about 3000 MANU/kg flour.

In one embodiment, the anti-staling amylase is the enzyme commercially known as Opticake™ (available from Novozymes). Typically, Opticake™ is added in an amount that is at least 333 MANU/kg. In one embodiment, Opticake™ is added in an amount that is up to 666 MANU/kg. In one embodiment, Opticake™ is added in an amount that is at least 333 MANU/kg but less than 666 MANU/kg .

In one embodiment, the anti-staling amylase is a G4 amylase. A non-limiting example of a G4 amylase includes GRINDAMYL™ POWERFresh (available from Danisco A/S).

### Dough

Dough generally comprises flour or meal such as wheat flour, wheat meal, corn flour, corn starch, rye meal, rye flour, oat flour, oat meal, soy flour, sorghum meal, sorghum flour, potato meal, potato flour or potato starch. Preferred for the present invention is wheat flour, and more preferably whole wheat flour. The word “whole” refers to the fact that all of the grain (bran, germ, and endosperm) is used in making the flour.

The dough is normally a leavened dough or a dough to be subjected to leavening. The dough may be leavened in various ways, such as by adding chemical leavening agents, e.g., sodium bicarbonate or by adding a leaven (fermenting dough), but it is preferred to leaven the dough by adding a suitable yeast culture, such as a culture of Saccharomyces cerevisiae (baker's yeast), e.g. a commercially available strain of S. cerevisiae.

The dough may also comprise other conventional dough ingredients, e.g.; proteins, such as milk powder, gluten, and soy; eggs (either whole eggs, egg yolks or egg whites); an oxidant such as ascorbic acid, potassium bromate, potassium iodate, azodicarbonamide (ADA) or ammonium persulfate; an amino acid such as L-cysteine; a sugar; a salt such as sodium chloride, calcium acetate, sodium sulfate or calcium sulfate.

The dough may comprise fat (triglyceride) such as granulated fat or shortening, but the invention is equally applicable to a dough which is made without addition of fat.

The dough may further comprise an emulsifier such as mono- or diglycerides, diacetyl tartaric acid esters of mono- or diglycerides, sugar esters of fatty acids, polyglycerol esters of fatty acids, lactic acid esters of monoglycerides, acetic acid esters of monoglycerides, polyoxyethylene stearates, or lysolecithin.

In a preferred embodiment, the dough comprises wheat flour; preferably 10% (w/w) or more of the total flour content is wheat flour, preferably at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or preferably at least 95% (w/w) of the flour is wheat flour.

In a preferred embodiment, the dough comprises whole wheat flour; preferably 10% (w/w) or more of the total flour content is whole wheat flour, preferably at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or preferably at least 95% (w/w) of the flour is whole wheat flour.

The dough may be prepared applying any conventional mixing process, such as the continuous mix process, straight-dough process, or the sponge and dough method. The dough may be fresh, frozen or par-baked. The dough may be a laminated dough.

### Baked Product

The process of the invention may be used for producing any kind of baked product prepared from dough, either of a soft or a crisp character, either of a white, light or dark type. The term baked product is understood to include any dough based products which are baked, steamed or fried. Non-limiting examples of baked products include bread (in particular white, whole-meal or rye bread), typically in the form of loaves or rolls, French baguette-type bread, bagels, pita bread, tortillas, cakes, pancakes, biscuits, cookies, pie crusts, doughnuts, steamed bread, pizza and the like.

### Composition for Preparing a Baked Product

The composition for preparing a baked product includes at least one peptidase of a type and in a sufficient amount to achieve a springiness of at least 0.5%, at least 1%, at least 2% or even at least 3% greater compared to a control baked product, at least one anti-staling amylase and optionally an additional enzyme as described below. The controlled baked product is prepared from the same dough composition but in the absence of the combination of anti-staling amylase and peptidase. The springiness remains over a 4-21 day shelf-life and preferably over a 14-21 day shelf-life.

The composition for preparing a baked product may be an enzyme preparation, e.g., in the form of a granulate or agglomerated powder. It may have a narrow particle size distribution with about 95% or more (by weight) of the particles in the range from 25 to 500 micrometer. Granulates and agglomerated powders may be prepared by conventional methods, e.g., by spraying the amylase and/or peptidase onto a carrier in a fluid-bed granulator. The carrier may have particulate cores having a suitable particle size. The carrier may be soluble or insoluble, e.g., a salt (such as NaCl or sodium sulfate), a sugar (such as sucrose or lactose), a sugar alcohol (such as sorbitol), starch, rice, corn grits, or soy.

The baking composition may, in addition to enzymes, comprise other baking ingredients, particularly flour. Thus, the composition may be a dough or a flour pre-mix.

### Additional Enzymes

Optionally, one or more additional enzymes may be used in addition to the combination of at least one peptidase and at least one anti-staling amylase. These additional enzymes include, but are not limited to, a cyclodextrin glucanotransferase, a transglutaminase, a lipase, a phospholipase, a cellulase, a hemicelluase, a glycosyltransferase, a branching enzyme (1,4-alpha-glucan branching enzyme), an oxidase, or a phosphodiesterase. Combinations of these additional enzymes may be included.

The additional enzyme may be of any origin, including mammalian and plant, and preferably of microbial (bacterial, yeast or fungal) origin.

The hemicellulase may be a pentosanase, e.g., a xylanase which may be of microbial origin, e.g., derived from a bacterium or fungus, such as a strain of Aspergillus, in particular of A. aculeatus, A. niger, A. awamori, or A. tubigensis, from a strain of Trichoderma, e.g., T. reesei, or from a strain of Humicola, e.g., H. insolens.

The lipase may be derived from a strain of Thermomyces (Humicola), Rhizomucor, Candida, Aspergillus, Rhizopus, or Pseudomonas, in particular from T. lanuginosus (H. ianuginosa), Rhizomucor miehei, C. antarctica, A niger, Rhizopus delemar, Rhizopus arrhizus or P. cepacia.

The phospholipase may have phospholipase A1 or A2, phospholipase C, or lysophospholipase activity; it may or may not have lipase activity. It may be of animal origin, e.g., from pancreas, snake venom or bee venom, or it may be of microbial origin, e.g., from filamentous fungi, yeast or bacteria, such as Aspergillus or Fusarium, e.g., A. niger, A. oryzae or F. oxysporum. Also the variants described in WO 00/32578 may be used.

The oxidase may be a monosaccharide oxidase such as glucose oxidase (EC 1.1.3.4), hexose oxidase (EC 1.1.3.5), galactose oxidase (EC 1.1.3.9) or pyranose oxidase (ECb 1.1.3.10). It may also be a deaminating oxidase such as L-amino acid oxidase (EC 1.4.3.2) or amine oxidase (EC 1.4.3.4). Alternatively, the oxidase may be a peroxidase, a laccase or a lipoxygenase. The oxidase may have optimum activity at pH 4-5.5. The glucose oxidase may be derived from a strain of Aspergillus or Penicillium, particularly A. niger, P. notatum, P. amagasakiense or P. vitale. The hexose oxidase may be one described in EP 833563. The pyranose oxidase may be one described in WO 97/22257, e.g., derived from Trametes, particularly T. hirsuta. The galactose oxidase may be one described in WO 00/50606. The deaminating oxidase may be one described in WO 97/21351, e.g. a benzylamine oxidase derived from Pichia, particularly P. pastoris.

The phophodiesterase may be from a mammalian or microbial source, e.g., from yeast or filamentous fungi, such as Aspergillus, Saccharomyces or Schizosaccharomyces, particularly A. oryzae, A. niger, Saccharomyces cerevisiae or Schizosaccharomyces pombe.

### Degree of Sequence Identity

For purposes of the present invention, the degree of sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

### EXAMPLES

The present invention is further described by means of the examples, presented below. The use of such examples is illustrative only and in no way limits the scope and meaning of the invention or of any exemplified term. Likewise, the invention is not limited to any particular preferred embodiments described herein. Indeed, many modifications and variations of the invention will be apparent to those skilled in the art upon reading this specification. The invention is therefore to be limited only by the terms of the appended claims along with the full scope of equivalents to which the claims are entitled.

Bread Baked from Dough with Peptidase and/or Amylase

Dough was prepared from the basic ingredients listed in Table 1 as well as the additional enzymes detailed in Tables 2 to 4.

TABLE 1

| Ingredient | Wt % |
|---|---|
| Whole wheat flour* | 45.5 |
| Water | 52 |
| Sodium chloride | 2 |
| Baker's yeast | 2.5 |

*commercial wheat flour of moderate quality (treated with ascorbic acid): ~11% protein, ~15% humidity

Dough was prepared from the ingredients detailed in Table 1, as well as the additional enzymatic components detailed in Table 2, and mixed with a spiral mixer for 4 minutes at 140 rpm and for 3 minutes at 280 rpm (Speed of the spiral rotor). The dough temperature was about 26° C. The dough was allowed to rise for 40 minutes at about 34° C. and high relative humidity, and, after degassing and molding, incubated for an additional 65 minutes at about 34° C. The dough was subsequently baked for 30 minutes at about 230° C. The dough and resulting baked bread was analyzed as detailed below.

### Texture Analyzer Method

Firmness and springiness was measured using a TA-XT plus texture analyzer (Stable Micro Systems, Godalming, UK) using a probe shaped as a cylindrical plate having a 100 mm diameter (P/100, Stable Micro Systems, Godalming, UK). For each time point, firmness and springiness was preferably measured on 2 loafs of bread with 3 samples taken from each bread. Thus, for each time point, the firmness and springiness values were the average of the six measurements taken. Each sample was a cube of the bread crumb with the dimension of 45 mm×45 mm×45 mm taken from the center of the bread so that the crust and bread crumb closest to the crust was removed.

Measurements of firmness and springiness were conducted as follows. The sample cube of bread crumb was first compressed 20% using the cylindrical plate probe moving at a speed of 1 mm/s. The maximum force at 20% compression was taken as the firmness of the sample cube. After the first compression the probe was returned to the original height of the sample cube with a speed of 1 mm/s. Thereafter, the sample cube was subjected to 5 consecutive compressions of 70% of the sample cube height with a probe speed of 6.5 mm/s. The springiness was determined as the percentage of the height of the sample cube after the probe was removed from the sample cube (force was less than 5 g) following the last compression relative to the original height of the sample cube.

### NMR Method

The mobility of free water, which can be correlated to the moist perception of the bread, was determined using a 24 MHz Maran Ultra Benchtop NMR (Resonance instruments, now Oxford instruments, Abingdon, UK) using a CPMG sequence. The analysis was run using the following settings, TAU=150 μs, Number of scans (NS)=4 Number of echoes (NECH)=512, Recycle Delay (RS)=3 s. The relaxation decay curve from each measurement was fitted using non-linear regression with 2 components and an off-set using the program WinFit (Resonance instruments, UK). As starting values for the fitting the following parameters were used, Tc1=1000 μs and Amp1=100; Tc2=10000 μs and Amp2=600; offset 20. The component with a relaxation time around 1500 μs was assigned bound water and the component with relaxation time around 7000-10000 μs was assigned free water.

### Slicing Assay

The slicing properties associated with bread are especially important when sliced bread is prepared on an industrial scale. Notably, consumers expect a certain level of uniformity to the sliced bread product which may be compromised by bread sticking to the knife used for slicing the bread. In particular, the stickiness of the baked bread impacts slicing as a “moist” crumb may stick to the knife during slicing and thus interfere therewith. In brief, after about 2 hrs after baking, bread is sliced using an electric knife and/or a Daub slicing machine. Namely, a Daub slicing machine “compresses” the bread while it is processed by the slicing machine.

### Example 1

Bread prepared from the ingredients detailed in Table 1 as well as the additional enzymatic components detailed in Table 2 below was qualitatively evaluated for texture as well as quantitatively evaluated at 14 and 21 days after baking using the Texture Analyzer and NMR methods. Notably, all Inventive Dough contained 1250 MANU/kg Novamyl along with a peptidase that differed for each Inventive Dough (i.e., EndoP2, EndoP4, or EndoP5) at a dosage of 0.25 mg/kg.

TABLE 2

| | Dough | | | | | |
|---|---|---|---|---|---|---|
| | C1 | C2 | C3 | I2 | I3 | I5 |
| EndoP2 | — | — | | — | 0.25 | — |
| (mg/kg) | | | | | | |
| EndoP4 | — | — | | 0.25 | — | — |
| (mg/kg) | | | | | | |
| EndoP5 | — | — | | — | — | 0.25 |
| (mg/kg) | | | | | | |
| Novamyl | — | 1250 | | 1250 | 1250 | 1250 |
| (MANU/kg) | | | | | | |
| Opticake | | | 333 | | | |
| (MANU/kg) | | | | | | |
| Fungamyl S | 59 | 59 | | 59 | 59 | 59 |
| (FAU/kg) | | | | | | |

Notes:
C = Control;
I = Inventive
Units reflect the amount of enzyme added per kg of flour in total.

Bread prepared with the enzymes in Table 2 was evaluated for texture; the results of which are summarized below in Table 3. Ratings were assigned to each bread based on the degree of moisture present in the crumb. A rating of “1” or “2” may be considered unacceptable as regards the degree of dryness or moistness of the crumb. Conversely, a rating in the range of “3” to “5” may be considered acceptable as regards the degree of dryness or moistness of the crumb. Importantly, the addition of a peptidase to the dough in addition to an amylase allows a higher amount of anti-staling amylase to be added while still maintaining a favorable degree of moistness in the baked product produced there from.

TABLE 3

| Bread | Peptidase | Comments | Rating |
|---|---|---|---|
| C1 | Control | very dry | 1 |
| C2 | Benchmark Novamyl | very moist | 1 |
| C3 | Benchmark Opticake | unacceptably moist | 2 |
| I2 | EndoP4 | very good | 5 |
| I3 | EndoP2 | slightly dry | 3 |
| I5 | EndoP5 | very good | 5 |

As noted above, bread was also evaluated using a Texture Analyzer after 14 and 21 days. All bread prepared from inventive dough with Novamyl and peptidase was less firm than bread prepared from control dough having the same composition but without added Novamyl or peptidase (i.e., Control Dough “C1”). The firmness of bread prepared from inventive dough with Novamyl and peptidase was within a desirable range that was comparable to that of bread prepared from dough with Novamyl but no added peptidase (i.e., Benchmark Dough “C2”). Consequently, the firmness of bread prepared from inventive dough with Novamyl and peptidase is sufficiently low for the baked products to be regarded as not stale and/or “fresh” for at least 14 and even at least 21 days after baking.

Bread prepared from dough with Novamyl and either peptidase EndoP4, EndoP2, or EndoP5 was substantially springier than bread prepared from control dough with Novamyl but no added peptidase (i.e., Benchmark Dough “C2”).

Thus, inclusion of Novamyl and either peptidase EndoP2, EndoP4, or EndoP5 in dough unexpectedly resulted in desirable levels of firmness as well as substantially improved springiness in bread produced there from. In addition, bread prepared from dough with Novamyl and peptidase EndoP4 retained a greater percentage of free water relative to bread prepared from dough with Novamyl and either peptidase EndoP2, or EndoP5.

Bread prepared from dough with an added anti-staling amylase in combination with at least one added peptidase was not only comparable or less firm initially (i.e., following storage for 4 days after baking) but also remained 50% less firm compared to bread prepared from control dough with no added anti-staling amylase or added peptidase following storage for 21 days after baking. Based on degree of the firmness of bread prepared from dough with an added anti-staling in combination with at least one added peptidase, such bread may be regarded as not stale and/or “fresh” for at least 21 days after baking. In addition to a superior softness over time, bread prepared from dough with at least one added anti-staling amylase and at least one added peptidase was also unexpectedly springy with an increase in springiness of at least 3% compared to bread prepared from control dough with an added anti-staling amylase but no added peptidase over the course of time examined (i.e., following storage for 4 to 21 days after baking).

Bread prepared from dough with at least one added anti-staling amylase in combination with at least one added peptidase was not only soft and springy, but also moist following storage for at least 21 days after baking. Bread prepared from dough with an anti-staling amylase in combination with a peptidase had at least a 3% increase and more preferably at least a 10% increase in initial free water mobility compared to bread prepared from dough with no added anti-staling amylase or peptidase. Furthermore, following storage for 21 days after baking, the free water mobility of bread prepared from dough with an anti-staling amylase in combination with a peptidase was approximately 5% greater compared to bread prepared from dough with no added anti-staling amylase or peptidase.

Lastly, bread prepared in accordance with the present invention produced slices of high quality when using an electric knife. Furthermore, embodiments of the present invention also produced quality bread slices when using a slicing machine. Namely, bread prepared from dough with 0.25 mg/kg 1 mg/kg ExoP4 peptidase in combination with 100 ppm/kg Novamyl produced bread slices of good quality when using a slicing machine, while bread prepared from dough with 0.25 mg/kg EndoP3 peptidase in combination with 100 ppm/kg Novamyl produced bread slices of even higher quality when using a slicing machine.

What is claimed is:

1. A process for preparing a baked product comprising:
adding to either a flour that is used to form a dough or directly to a dough:
at least one maltogenic alpha-amylase in an amount sufficient to decrease firmness of the baked product; and
at least one endopeptidase in an amount sufficient to increase springiness of the baked product; and
baking the dough to form the baked product, and wherein the added endopeptidase maintains springiness of the baked product for a period of at least 4-21 days after baking.

2. The process of claim 1, wherein the added endopeptidase and the added maltogenic alpha-amylase is comprised in a premix composition.

3. The process of claim 1, wherein the at least one maltogenic alpha-amylase is added in an amount of 0.1-10,000 MANU per kg of flour

4. The process of claim 1, wherein the at least one maltogenic alpha-amylase is added in an amount of 1-5000 MANU per kg of flour.

5. The process of claim 1, wherein the at least one maltogenic alpha-amylase is added in an amount of 5-2000 MANU per kg of flour.

6. The process of claim 1, wherein the at least one maltogenic alpha-amylase is added in an amount of 10-1000 MANU per kg of flour.

7. The process of claim 1, wherein the at least one endopeptidase is selected from the group consisting of SEQ ID NO: 8, SEQ ID NO: 10, SEQ ID NO: 11, SEQ ID NO: 12, SEQ NO: 13, SEQ ID NO: 14, and combinations thereof.

8. The process of claim 1, wherein the at least one endopeptidase is selected from the group consisting of an endopeptidase having at least 80% identity to any of SEQ ID NO: 8, SEQ ID NO: 10, SEQ ID NO: 11, SEQ ID NO: 12, SEQ NO: 13, SEQ ID NO: 14, and combinations thereof.

9. The process of claim 1, wherein the at least one endopeptidase is selected from the group consisting of an endopeptidase having at least 90% identity to any of SEQ ID NO: 8, SEQ ID NO: 10, SEQ ID NO: 11, SEQ ID NO: 12, SEQ NO: 13, SEQ ID NO: 14, and combinations thereof.

10. The process of claim 1, wherein the at least one endopeptidase is selected from the group consisting of an endopeptidase having at least 95% identity to any of SEQ ID NO: 8, SEQ ID NO: 10, SEQ ID NO: 11, SEQ ID NO: 12, SEQ NO: 13, SEQ ID NO: 14, and combinations thereof.

11. The process of claim 1, wherein the at least one endopeptidase is added in an amount of about 0.01 mg/kg to about 35 mg/kg of flour.


SEQUENCE LISTING (15 sequences)

SEQ ID NO: 1 - protein, 496 aa, Aspergillus oryzae
MRSLLWASLLSGVLAGRALVSPDEFPEDIQLEDLLEGSQQLEDFAYAYPERNRVFGGKAHDDTVNYLYEELKKTGYYDVYKQPQVHLWSNADQTLKVGDEEIEAKTMTYSPSVEVTADVAVVKNLGCSEADYPSDVEGKVALIKRGECPFGDKSVLAAKAKAAASIVYNNVAGSMAGTLGAAQSDKGPYSAIVGISLEDGQKLIKLAEAGSVSVDLWVDSKQENRTTYNVVAQTKGGDPNNVVALGGHTDSVEAGPGINDDGSGIISNLVIAKALTQYSVKNAVRFLFWTAEEFGLLGSNYYVSHLNATELNKIRLYLNFDMIASPNYALMIYDGDGSAFNQSGPAGSAQIEKLFEDYYDSIDLPHIPTQFDGRSDYEAFILNGIPSGGLFTGAEGIMSEENASRWGGQAGVAYDANYHAAGDNMTNLNHEAFLINSKATAFAVATYANDLSSIPKRNTTSSLHRRARTMRPFGKRAPKTHAHVSGSGCWHSQVEA

SEQ ID NO: 2 - protein, 555 aa, Aspergillus oryzae
MRGYEFLSVLPLVAASWALPGSTPASVGRRQLPKNPTGVKTLTTANNVTIRYKEPGAEGVCETTPGVKSYSGYVDTSPESHTFFWFFEARHNPETAPITLWLNGGPGSDSLIGLFEELGPCHVNSTFDDYINPHSWNEVSNLLFLSQPLGVGFSYSDTVDGSINPVTGVVENSSFAGVQGRYPTIDATLIDTTNLAAEAAWEILQGFLSGLPSLDSRVQSKDFSLWTESYGGHYGPAFFNHFYEQNERIANGSVNGVQLNFNSLGIINGIIDEAIQAPYYPEFAVNNTYGIKAVNETVYNYMKFANQMPNGCQDLISTCKQTNRTALADYALCAEATNMCRDNVEGPYYAFAGRGVYDIRHPYDDPTPPSYYNKFLAKDSVMDAIGVNINYTQSNNDVYYAFQQTGDFVWPNFIEDLEEILALPVRVSLIYGDADYICNWFGGQAVSLAANYSQAAQFRSAGYTPLKVNGVEYGETREYGNFSFTRVYEAGHEVPYYQPIASLQLFNRTIFGWDIAEGQKKIWPSYKTNGTATATHTQSSVPLPTATSMSSVGMA

SEQ ID NO: 3 - protein, 355 aa, Lactococcus lactis cremori
MELFDKVKALTEIQATSGFEGPVRDYLKARMVELGYQPEFDGLGGIFVTKASKVENAPRIMVAAHMDEVGFMVSSIKADGTFRVVPLGGWNPLVVSGQRFTLFTRTGKKIPVVTGGLPPHLLRGTGVTPQIPAISDIIFDGAFENAAEAAEFGIAQGDLIIPETETILSANGKNIISKAWDNRYGCLMILELLEFLADKELPVTLIIGANVQEEVGLRGAKVSTTKFNPDLFFAVDCSPASDTFGDDNGRLGEGTTLRFFDPGHIMLPGMKNFLLDTANHAKVKTQVYMAKGGTDAGAAHLANGGVPSTTIGVVARYIHSHQTIFNIDDFLQAQTFLRAIITSLNTEKVAEIKNY

SEQ ID NO: 4 - protein, 449 aa, Bacillus licheniformis
MKRKMMMFGLALSIIAGGVVADGTGNAAQAAPQETAIAKDIEKFSKKFNENRAYQTIYHLSETIGPRVTGTAEEKKSAAFIASQMKKSNLKVSTQKFSIPDRLEGTLTVQGNNVPARPAAGSAPTAAEGLAAPLYDAGLGLPGDFTEEAKGKIAVILRGELTFYEKAKNAADAGASGVIIYNNVDSLVPLTPNLSGNKVDIPVVGVKKEDGEKLLSEQEAILKLKAHKNQTSQNVIGVRKAKGVKNPDIVYVTSHYDSVPYAPGANDNASGTSVVLELARILKTVPADKEIRFITFGAEEIGLLGSRHYVSTLSNQEVKRSVANFNLDMVATSWENASQLYINTPDGSANLVWQLSKAASLSLGKDVLFLHQGGSSDHVPFHEAGIDSANFIWREPGTGALEPWYHTPYDTIEHISKDRLKTAGQIAGTAVYNFTKKENRKPSYSSVAQ

SEQ ID NO: 5 - protein, 542 aa, Aspergillus oryzae
MRVLPATLLVGAASAAVPPLQQVLGRPEEGMSFSKPLHAFQEQLKTLSEDARKLWDEVANYFPDSMDHSPIFSLPKKHTRRPDSHWDHIVRGSDVQKIWVNNADGEKEREIDGKLEAYDLRIKKADPSALGIDPNVKQYTGYLDDNGNDKHLFYWFFESRNDPKNDPVVLWLNGGPGCSSLTGLFMELGPSSIDENIKPVYNDFSWNSNASVIFLDQPVNVGYSYSGSAVSDTVAAGKDVYALLSLFFKQFPEYAEQDFHIAGESYAGHYIPVFASEILAHKNRNINLKSVLIGNGLTDGLTQYGYYRPMGCGEGGYKAVLDEATCESMDNALPRCRSMIESCYNSESAWVCVPASIYCNNALIGPYQRTGQNVYDVRSKCEDESNLCYKGMGYVSEYLNKAEVREAVGAEVGGYDSCNFDINRNFLFHGDWMKPYHRLVPGLLEQIPVLIYAGDADYICNWLGNKAWTEALEWPGQKEYASAELEDLKIEQNEHTGKKIGQVKSHGNFTFMRLYGGGHMVPMDQPEASLEFFNRWLGGEWF

SEQ ID NO: 6 - protein, 771 aa, Aspergillus oryzae
MKYSKLLLLLVSVVQALDVPRKPHAPTGEGSKRLTFNETVVKQAITPTSRSVQWLSGAEDGSYVYAAEDGSLTIENIVTNESRTLIPADKIPTGKEAFNYWIHPDLSSVLWASNHTKQYRHSFFADYYVQDVESLKSVPLMPDQEGDIQYAQWSPVGNTIAFVRENDLYVWDNGTVTRITDDGGPDMFHGVPDWIYEEEILGDRYALWFSPDGEYLAYLSFNETGVPTYTVQYYMDNQEIAPAYPWELKIRYPKVSQTNPTVTLSLLNIASKEVKQAPIDAFESTDLIIGEVAWLTDTHTTVAAKAFNRVQDQQKVVAVDTASNKATVISDRDGTDGWLDNLLSMKYIGPIKPSDKDAYYIDISDHSGWAHLYLFPVSGGEPIPLTKGDWEVTSILSIDQERQLVYYLSTQHHSTERHLYSVSYSTFAVTPLVDDTVAAYWSASFSANSGYYILTYGGPDVPYQELYTTNSTKPLRTITDNAKVLEQIKDYALPNITYFELPLPSGETLNVMQRLPPGFSPDKKYPILFTPYGGPGAQEVTKRWQALNFKAYVASDSELEYVTWTVDNRGTGFKGRKFRSAVTRQLGLLEAEDQIYAAQQAANIPWIDADHIGIWGWSFGGYLTSKVLEKDSGAFTLGVITAPVSDWRFYDSMYTERYMKTLSTNEEGYETSAVRKTDGFKNVEGGFLIQHGTGDDNVHFQNSAALVDLLMGDGVSPEKLHSQWFTDSDHGISYHGGGVFLYKQLARKLYQEKNRQTQVLMHQWTKKDLEE

SEQ ID NO: 7 - protein, 355 aa, Aspergillus oryzae
MRLVASLTALVALSVPVFPAAVNVKRASSYLEITLSQVSNTLIKAVVQNTGSDELSFVHLNFFKDPAPVKKVSVYRDGSEVQFEGILSRYKSTGLSRDAFTYLAPGESVEDVFDIASTYDLTSGGPVTIRTEGVVPYATANSTDIAGYISYSSNVLTIDVDGAAAATVSKAITPLDRRTRISSCSGSRQSALTTALRNAASLANAAADAAQSGSASKFSEYFKTTSSSTRQTVAARLRAVAREASSSSSGATTYYCDDPYGYCSSNVLAYTLPSYNIIANCDIFYTYLPALTSTCHAQDQATTALHEFTHAPGVYSPGTDDLAYGYQAAMGLSSSQAVMNADTYALYANAIYLGC

SEQ ID NO: 8 - protein, 248 aa, Fusarium oxysporum
MVKFASVVALVAPLAAAAPQEIPNIVGGTSASAGDFPFIVSISRNGGPWCGGSLLNANTVLTAAHCVSGYAQSGFQIRAGSLSRTSGGITSSLSSVRVHPSYSGNNNDLAILKLSTSIPSGGNIGYARLAASGSDPVAGSSATVAGWGATSEGGSSTPVNLLKVTVPIVSRATCRAQYGTSAITNQMFCAGVSSGGKDSCQGDSGGPIVDSSNTLIGAVSWGNGCARPNYSGVYASVGALRSFIDTYA

SEQ ID NO: 9 - protein, 430 aa, Rhizomucor miehei
MLFSQITSAILLTAASLSLTTARPVSKQSESKDKLLALPLTSVSRKFSQTKFGQQQLAEKLAGLKPFSEAAADGSVDTPGYYDFDLEEYAIPVSIGTPGQDFLLLFDTGSSDTWVPHKGCTKSEGCVGSRFFDPSASSTFKATNYNLNITYGTGGANGLYFEDSIAIGDITVTKQILAYVDNVRGPTAEQSPNADIFLDGLFGAAYPDNTAMEAEYGSTYNTVHVNLYKQGLISSPLFSVYMNTNSGTGEVVFGGVNNTLLGGDIAYTDVMSRYGGYYFWDAPVTGITVDGSAAVRFSRPQAFTIDTGTNFFIMPSSAASKIVKAALPDATETQQGWVVPCASYQNSKSTISIVMQKSGSSSDTIEISVPVSKMLLPVDQSNETCMFIILPDGGNQYIVGNLFLRFFVNVYDFGNNRIGFAPLASAYENE

SEQ ID NO: 10 - protein, 231 aa, Porcine
FPTDDDDKIVGGYTCAANSIPYQVSLNSGSHFCGGSLINSQWVVSAAHCYKSRIQVRLGEHNIDVLEGNEQFINAAKIITHPNFNGNTLDNDIMLIKLSSPATLNSRVATVSLPRSCAAAGTECLISGWGNTKSSGSSYPSLLQCLKAPVLSDSSCKSSYPGQITGNMICVGFLEGGKDSCQGDSGGPVVCNGQLQGIVSWGYGCAQKNKPGVYTKVCNYVNWIQQTIAAN

SEQ ID NO: 11 - protein, 521 aa, Bacillus amyloliquefaciens
MGLGKKLSVAVAASFMSLTISLPGVQAAENPQLKENLTNFVPKHSLVQSELPSVSDKAIKQYLKQNGKVFKGNPSERLKLIDQTTDDLGYKHFRYVPVVNGVPVKDSQVIIHVDKSNNVYAINGELNNDVSAKTANSKKLSANQALDHAYKAIGKSPEAVSNGTVANKNKAELKAAATKDGKYRLAYDVTIRYIEPEPANWEVTVDAETGKILKKQNKVEHAATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

SEQ ID NO: 12 - protein, 389 aa, Aspergillus oryzae
ADYQVYAWGINDPTEGPRTVISDPWDSSASAFTWISDGENNYTTTRGNNGIAQSNPTGGSQYLKNYRPDSPDLKFQYPYSLNATPPESYIDASITQLFYTANTYHDLLYTLGFNEEAGNFQYDNNGKGGAGNDYVILNAQDGSGTNNANFATPPDGQPGRMRMYIWTESQPYRDGSFEAGIVIHEYTHGLSNRLTGGPANSRCLNALESGGMGEGWGDFMATAIRLKAGDTHSTDYTMGEWAANKKGGIRAYPFSTSLETNPLTYTSLNELDEVHAIGAVWANVLYELLWNLIDKHGKNDGPKPEFKDGVPTDGKYLAMKLVIDGIALQPCNPNCVQARDAILDADKALTDGANKCEIWKAFAKRGLGEGAEYHASRRVGSDKVPSDAC

SEQ ID NO: 13 - protein, 188 aa, Nocardiopsis sp.
ADIIGGLAYTMGGRCSVGFAATNAAGQPGFVTAGHCGRVGTQVTIGNGRGVFEQSVFPGNDAAFVRGTSNFTLTNLVSRYNTGGYATVAGHNQAPIGSSVCRSGSTTGWHCGTIQARGQSVSYPEGTVTNMTRTTVCAEPGDSGGSYISGTQAQGVTSGGSGNCRTGGTTFYQEVTPMVNSWGVRLRT

SEQ ID NO: 14 - protein, 355 aa, Thermoascus aurantiacus; identical to SEQ ID NO: 7

SEQ ID NO: 15 - protein, 272 aa, Alicyclobacillus sp
MNGTSVWKASGIAAASCLTAAALLAWPHATSTLDASPAIFHAPRHALSPNTSPKPNSVQAQNFGWSASNWSGYAVTGSTYNDITGSWIVPAVSPSKRSTYSSSWIGIDGFNNSDLIQTGTEQDYVNGHAQYDAWWEILPAPETVISNMTIAPGDRMSAHIHNNGNGTWTITLTDVTRNETFSTTQSYSGPGSSAEWIQEAPEIGGRIATLANYGETTFDPGTVNGGNPGFTLSDAGYMVQNNAVVSVPSAPDSDTDGFNVAYGSNQPSPPAS